(19) United States
(12) Patent Application Publication
(10) Pub. No.: US 2001/0003470 A1
(43) Pub. Date: Jun. 14, 2001

(54) Liquid crystal display with black matrix of low reflectivity

(76) Inventors: Sang Un Choi, Kyoungki-do (KR); Youn Joo Kim, Kyoungki-do (KR)

Correspondence Address: Thomas F. Peterson, c/o Ladas & Parry, Suite 1200, 224 South Michigan Avenue, Chicago, IL, 60604, US

(21) Appl. No.: 09/727,555

(22) Filed: Dec. 1, 2000

(30) Foreign Application Priority Data
Dec. 8, 1999 (KR) 99-55923

(51) Int. Cl. G02F 1/13; G02F 1/1335; G02B 5/20

(52) U.S. Cl. 349/1; 430/7

(57) ABSTRACT

Disclosed is a liquid crystal display (LCD) with black matrixes of low reflectivity capable of reducing the reflection of back light. The black matrix of the disclosed LCD includes a photoshield layer formed on the back surface of a front substrate, and at least one internal photo-interference layer formed over the photoshield layer. The internal photo-interference layer has a refraction index different from that of the photoshield layer. The internal photo-interference layer has a double-layer structure consisting of a chromium nitride layer and a chromium oxide layer.

### BACKGROUND OF THE INVENTION

1. Field of the Invention

The present invention relates to a liquid crystal display (LCD), and more particularly to an LCD with a black matrix of low reflectivity.

2. Description of the Related Art

LCD is a flat panel display using electro-optic properties of a liquid crystal layer interposed between two substrates. An example of a conventional LCD is illustrated in FIG. 1.

FIG. 1 is a sectional view illustrating an essential part of an LCD having a conventional simple shield type black matrix.

As shown in FIG. 1, the LCD having a simple shield type black matrix includes a back substrate 13 and a front substrate 15 which are arranged in parallel to each other and a liquid crystal layer 17 which is interposed between the substrates 13 and 15. The LCD also includes a back polarizer 12 attached to the back surface of the back substrate 13, and a front polarizer 16 attached to the front surface of the front substrate 15.

R, G, and B color filter layers 14-1, 14-2, and 14-3 are formed on the back surface of the front substrate 15 such that they are separated from one another by black matrixes 19-1, 19-2, and 19-3 formed on the back surface of the front substrate 15. The black matrixes are arranged between adjacent ones of the color filter layers 14-1, 14-2, and 14-3 and they are flush with one another.

Pixel electrodes respectively corresponding to the color filter layers 14-1, 14-2, and 14-3 and thin film transistors serving as active devices are formed on the front surface of the back substrate 13. A back light source 11 is arranged behind the back polarizer 12.

The black matrixes 19-1, 19-2, and 19-3 are photoshield films for shielding an external light, thereby preventing an increase in leakage current at the thin film transistors.

Now, the operation of the LCD having the above mentioned configuration will be described with reference to FIG. 1.

Light emitted from the back light source 11 are linearly polarized while passing through the back polarizer 12, and then pass through the back substrate 13. The back light emerging from the back substrate 13 reach the black matrixes 19-1, 19-2, and 19-3 and the color filter layers 14-1, 14-2, and 14-3, after passing through the liquid crystal layer 17. Assuming that the liquid crystal layer 17 has a twisted liquid crystal structure, the polarization vectors of the back light are rotated by an angle of 90°.

The back light reaching each of the color filter layers 14-1, 14-2, and 14-3 is colored, and then externally emitted through the front polarizer 16, thereby being recognized as information.

Meanwhile, the back light reaching the black matrixes, 19-1, 19-2 and 19-3, are reflected toward the back substrate 13, and then are applied to a channel region in an associated one of the thin film transistors, thereby resulting in a production of photocurrent noises.

The conventional simple shield type black matrixes 19-1, 19-2, and 19-3 have respectively a photoshield layer made of a chromium material. The intensity distribution, that is, luminance distribution, of the back light reflected from the simple shield type black matrix is depicted in FIGS. 2A to 2C, respectively.

FIG. 2A illustrates the luminance distribution of the back light reflected by the black matrix 19-1 after passing through the R color filter layer 14-1. FIG. 2B illustrates the luminance distribution of the back light reflected by the black matrix 19-2 after passing through the G color filter layer 14-2. FIG. 2C illustrates the luminance distribution of the back light reflected by the black matrix 19-3 after passing through the B color filter layer 14-3. Referring to FIGS. 2A to 2C, it can be found that the back light reflected by the black matrix 19-1 after passing through the R color filter layer 14-1 exhibits a luminance of 83.9 cd/m², the back light reflected by the black matrix 19-2 after passing through the G color filter layer 14-2 exhibits a luminance of 90.4 cd/m², the back light reflected by the black matrix 19-3 after passing through the B color filter layer 14-3 exhibits a luminance of 90.6 cd/m². In this case, the luminance of the back light emitted from the back light source 11 is 1,300 cd/m².

Meanwhile, the luminance distribution of back light beams of a visible range passing through the back light source 11 and the back polarizer 12 in the LCD including the above mentioned conventional simple shield type black matrix is depicted in FIG. 3. In FIG. 3, the solid line is indicative of the luminance of the back light emitted from the back light source 11 whereas the dotted line is indicative of the luminance of the back light emerging from the back polarizer 12.

Referring to FIG. 3, it can be found that the back light emerging from the back polarizer 12 has a luminance of 559 cd/m². It can also be found that the peak luminance wavelengths of the back light coincide with respective wavelength of red, green, and blue light.

In this case, the back polarizer 12 has a transmittance of 43% and a reflectivity of 47% ((83.9+90.4+90.6)/559×100).

In the conventional LCD exhibiting such a reflectivity, the off current of each thin film transistor increases from several pA to several ten pA for every frame, and the voltage applied to the liquid crystal layer 17 decreases gradually. As a result, there is a voltage difference between positive and negative voltages, thereby causing the display screen to flicker. The generation of such flicker increases as the luminance of back light source increases according to the gradual increase in the size of a display screen.

On the other hand, when an external light, such as a light emitted from a fluorescent lamp, is reflected by the black matrix, a degradation occurs in contrast and visual recognizability. In order to preventing such a degradation in visual recognizability, an LCD including an external light anti-reflection type black matrix has been proposed.

FIGS. 4 and 5 are sectional views respectively illustrating the conventional external light anti-reflection type black matrix.

The external light anti-reflection type black matrix illustrated in FIG. 4 has a double-layer structure consisting of a chromium oxide layer 21 and a chromium layer 22 sequentially formed over a front substrate 20. The chromium layer 22 serves as a photoshield film whereas the chromium oxide layer 21 serves as a photo-interference layer.

The external light anti-reflection type black matrix illustrated in FIG. 5 has a triple-layer structure consisting of a chromium nitride (CrN_{y}) layer 31, a chromium oxide layer 32 and a chromium layer 33 sequentially formed over a front substrate 30. The chromium layer 33 serves as a photoshield film whereas the chromium nitride layer 31 and chromium oxide layer 32 serve as photo-interference layers.

FIG. 6 is a graph depicting the reflectivity of the external light anti-reflection type black matrix in FIG. 5. The abscissa of the graph is indicative of the wavelength of the external light whereas the ordinate is indicative of the reflectivity or reflection rate. Referring to FIG. 6, it can be found that the black matrix exhibits a reflectivity of 5 to 7% at the wavelength of the external light ranging from 380 nm to 780 nm. Thus, this black matrix exhibits a reduced reflectivity of less than 10% and provides an improvement in a visual recognizability.

In LCDs including the above mentioned external light anti-reflection type black matrix of FIG. 4 or 5, however, back light is reflected in a range of 40 to 50% by the chromium layer of the black matrix serving as a photoshield layer.

### SUMMARY OF THE INVENTION

Therefore, an object of the present invention is to provide an LCD with black matrixes of low reflectivity capable of reducing the reflection of back light in order to solve the above mentioned problems involved in the related art.

The present invention provides an LCD including a front substrate on which color filters and black matrixes are formed such that the black matrixes are respectively arranged between adjacent ones of the color filters. In order to prevent back light beams passing through a liquid crystal layer from being reflected toward the liquid crystal layer, thereby achieving a reduction in flicker, the black matrix comprises a photoshield layer formed on a back surface of the front substrate, and at least one internal photo-interference layer formed over the photoshield layer. The internal photo-interference layer has a refraction index different from that of the photoshield layer.

The black matrix may further comprise at least one external photo-interference layer formed between the front substrate and the photoshield layer. The external photo-interference layer has a refraction index different from that of the photoshield layer.

The above objects, and other features and advantages of the present invention will become more apparent after a reading of the following detailed description taken in conjunction with the accompanying drawings.

### BRIEF DESCRIPTION OF THE DRAWINGS

FIG. 1 is a sectional view illustrating an essential part of an LCD having a conventional simple shield type black matrix;

FIGS. 2A to 2C are graphs respectively depicting the luminance distributions of back light reflected by each of the black matrixes in the LCD of FIG. 1, and more particularly, FIG. 2A illustrates the luminance distribution of the back light reflected by the black matrix 19-1 after passing through the R color filter layer 14-1, FIG. 2B illustrates the luminance of the back light reflected by the black matrix 19-2 after passing through the G color filter layer 14-2, and FIG. 2C illustrates the luminance of the back light reflected by the black matrix 19-3 after passing through the B color filter layer 14-3;

FIG. 3 is a graph depicting the luminance distributions of back light of a visible range passing through a back light source and a back polarizer in the LCD of FIG. 1;

FIGS. 4 and 5 are sectional views respectively illustrating an external light anti-reflection type black matrix;

FIG. 6 is a graph depicting the reflectivity of the external light anti-reflection type black matrix in FIG. 5;

FIG. 7 is a sectional view illustrating black matrixes of low reflectivity according to one embodiment of the present invention;

FIG. 8 is a schematic view illustrating the principle of the reflection of back light being reduced in FIG. 7;

FIGS. 9A to 9C are graphs respectively depicting the luminance distributions of back light reflected by each of black matrixes in FIG. 7, and more particularly, FIG. 7A illustrates the luminance distribution of the back light reflected by the black matrix 19-1′ after passing through the R color filter layer, FIG. 7B illustrates the luminance of the back light reflected by the black matrix 19-2′ after passing through the G color filter layer, and FIG. 7C illustrates the luminance of the back light reflected by the black matrix 19-3′ after passing through the B color filter layer;

FIG. 10 is a graph depicting a variation in reflectivity depending on the thickness of a chromium oxide layer in the LCD of FIG. 7;

FIG. 11 is a graph depicting a variation in off current in each thin film transistor included in the LCD of FIG. 7;

FIG. 12 is a sectional view illustrating the black matrixes of low reflectivity according to another embodiment of the present invention; and

FIG. 13 is a graph depicting the relation between the thickness and reflectivity of a chromium oxide layer depending on the thickness of a chromium nitride layer in the LCD of FIG. 12.

### DESCRIPTION OF THE PREFERRED EMBODIMENTS

Now, preferred embodiments of the present invention will be described in detail, with reference to the annexed drawings. For the convenience of description, elements having the same functions as those of the above mentioned conventional LCDs are denoted by the same reference numerals and names as those of the conventional LCDs.

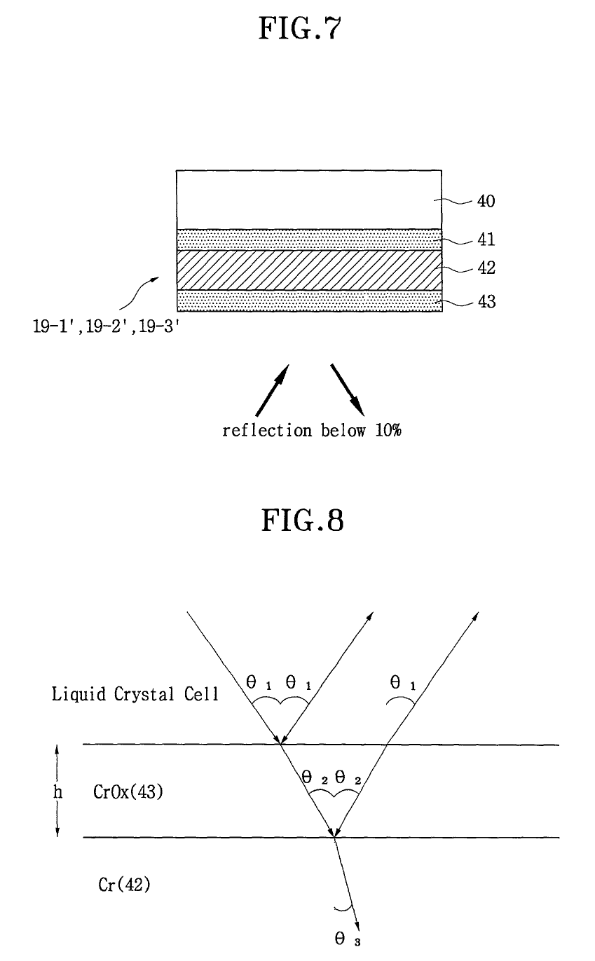

FIG. 7 is a sectional view illustrating the black matrixes of low reflectivity according to one embodiment of the present invention.

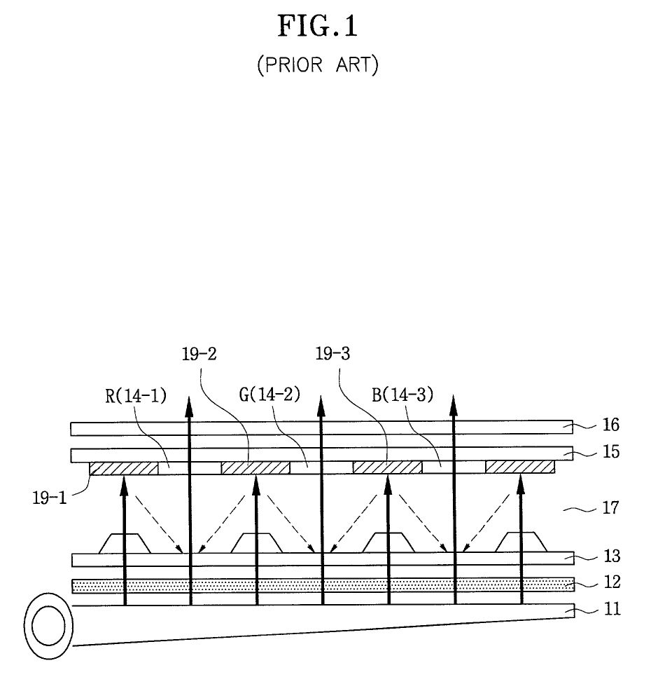

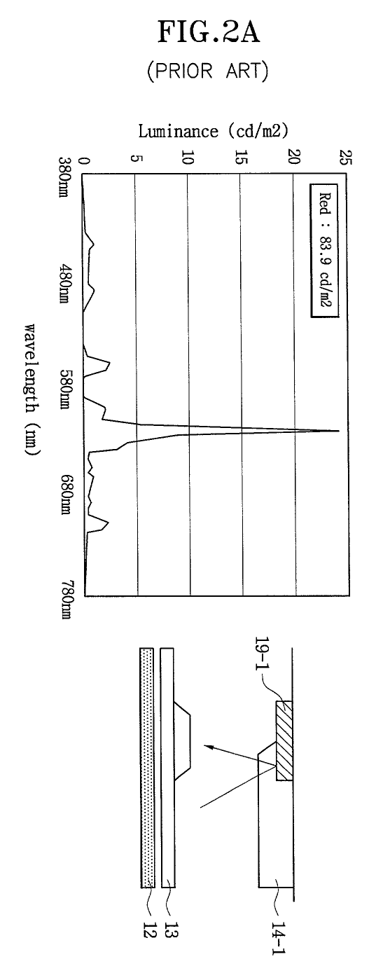

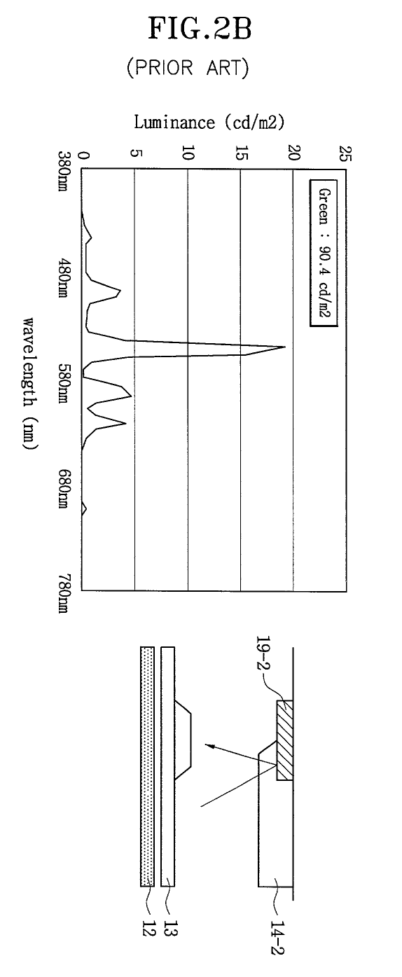

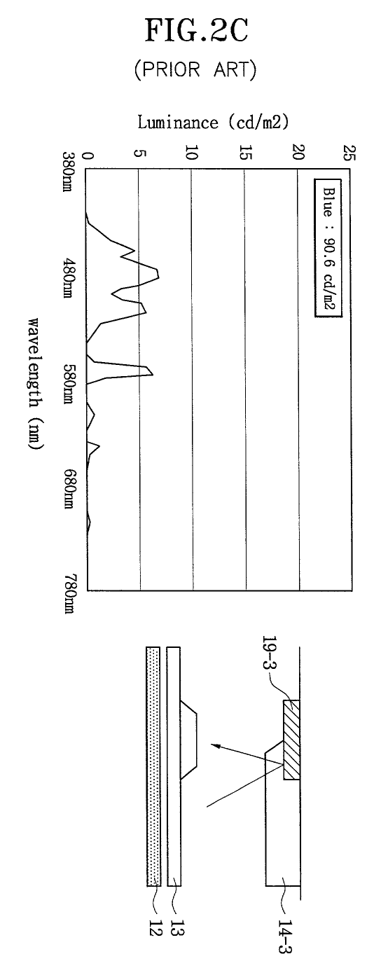

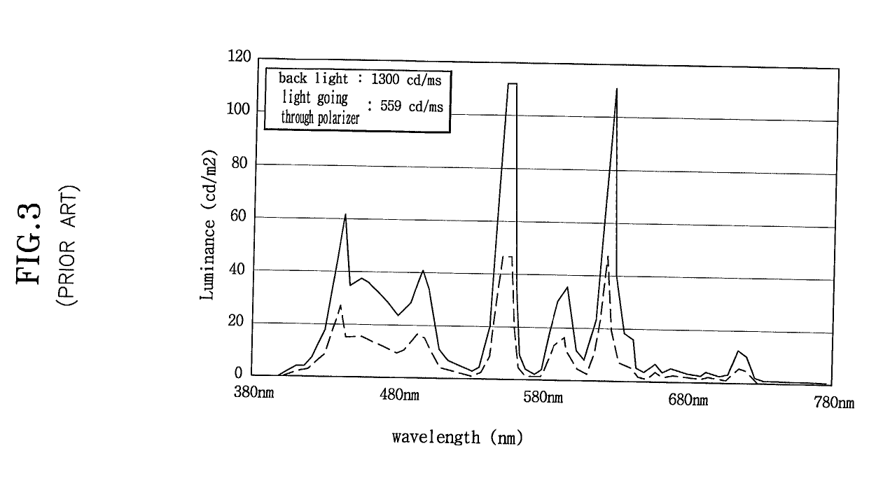

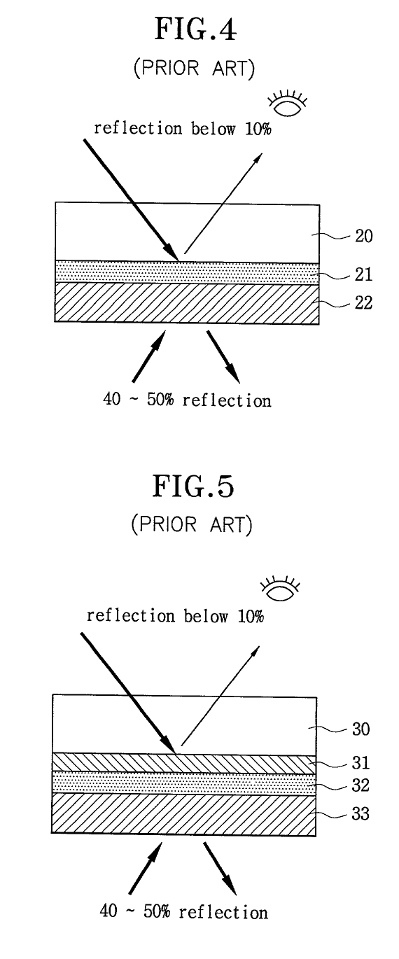

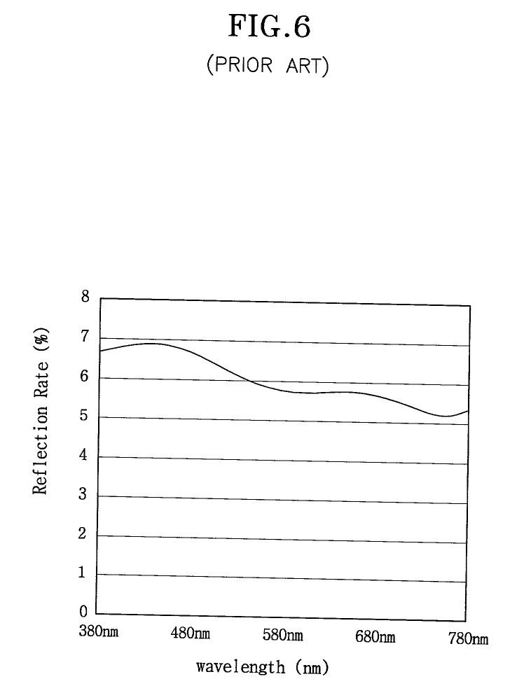

The black matrixes 19-1′, 19-2′, and 19-3′ shown in FIG. 7 respectively correspond to the black matrixes 19-1, 19-2, and 19-3 of FIG. 1. The black matrix comprises a chromium oxide layer 41 formed over the back surface of a front substrate 40 corresponding to the front substrate 15 of FIG. 1, a chromium layer 42 formed over the chromium oxide layer 41, and a chromium oxide layer 43 formed over the chromium layer 42. The chromium oxide layer 41 serves as an external photo-interference layer. The chromium layer 42 serves as a photoshield layer whereas the chromium oxide layer 43 serves as an internal photo-interference layer.

The principle of the reflection of back light being reduced by the black matrix portions 19-1′, 19-2′, and 19-3′ each having the above mentioned layer structure will be described hereinafter, with reference to FIG. 8 along with FIG. 1.

Light beams emitted from the back light source 11 reach the chromium oxide layer 41 and the color filter layers 14-1, 14-2, and 14-3, respectively, after passing through the back polarizer 12, the back substrate 13, and the liquid crystal layer 17. The back light beam reaching each of the color filter layers 14-1, 14-2, and 14-3 is colored, and then externally emitted through the front polarizer 16, thereby being recognized as information. In this case, the luminance of the back light emitted from the back light source 11 is 1,300 cd/m². The back light exhibits a luminance of 559 cd/m² after passing though the back polarizer 12. Accordingly, the transmittance of the back polarizer 12 is 43%.

Meanwhile, the back light beam reaching the chromium oxide layer 43 is partially reflected at the interface between the liquid crystal layer 17 and chromium oxide layer 43 (reflection angle of θ₁) while the unreflected back light partially passing through the chromium oxide layer 43 (refraction angle of θ₂). A large fraction of the back light beam passing through the chromium oxide layer 43 is reflected at the interface between the chromium oxide layer 43 and chromium layer 42 while the unreflected back light passing through the chromium layer 42 with a refraction angle of θ₃.

An interference occurs between the back light reflected at the interface between the liquid crystal layer 17 and chromium oxide layer 43 and the back light passing through the liquid crystal layer 17 after being reflected at the interface between the chromium layer 42 and chromium oxide layer 43. This interference will now be described. For the convenience of description, the back light reflected again at the interface between the liquid crystal layer 17 and chromium oxide layer 43 toward the chromium layer 42 is disregarded.

Assuming that λ represents the wavelength of the back light, the external complex Fresnel reflection coefficient r for S and P waves is expressed by the following expression:

r=(r₁₂+r₂₃ exp(2jβ))/(1+f₁₂r₂₃ exp(2jβ))

where, β corresponds to “(2π n₂hcosθ₂)/λ” (where, h represents the thickness of the chromium oxide layer 43, n₂ represents the refraction index of the chromium oxide layer 43, θ₂ represents the refraction angle at the interface between the liquid crystal layer 17 and the chromium oxide layer 43), r₁₂ represents the Fresnel reflection coefficient at the interface between the liquid crystal layer 17 and chromium oxide layer 43, and r₂₃ represents the Fresnel reflection coefficient at the interface between the chromium oxide layer 43 and chromium layer 42.

Using the Law of Snell, the reflection angle θ₂ and the reflection angle θ₃ can be expressed by a function of the reflection angle θ₁ at the interface between the liquid crystal layer 17 and chromium oxide layer 43, as follows:

cos θ₂=(1−sin² θ₁n₁²/n₂^{t})^{½}

cos θ₃=(1−sin² θ₁n₁²/n₃²)^{½}

where, n₁ represents the refraction index of the liquid crystal layer 17, n₂ represents the refraction index of the chromium oxide layer 43, and n₃ represents the refraction index of the chromium layer 42.

The reflectivity R of the liquid crystal layer 17 is expressed by the following expression:

R=|r|²≡R(θ₁, h, n₁, n₁, n₁)

In accordance with this expression, the reflectivity R is a function of the refraction index n₃ of the chromium layer 43, the refraction index n₂ of the chromium layer 42, and the thickness of the chromium oxide layer 43, assuming that reflection angle θ₁ is zero. For example, a destructive interference occurs at an optical path difference of m(an integer) times 2hn₂/λ, thereby resulting in a reduction in the reflected amount of light. At an optical path difference of (m +½) times 2hn₂/λ, a construction interference occurs, thereby resulting in an increase in the reflected amount of light. Accordingly, the reflection of the back light can be reduced by appropriately adjusting the thicknesses and refraction index of the chromium oxide layer 43 and the reflection index of the chromium layer 42.

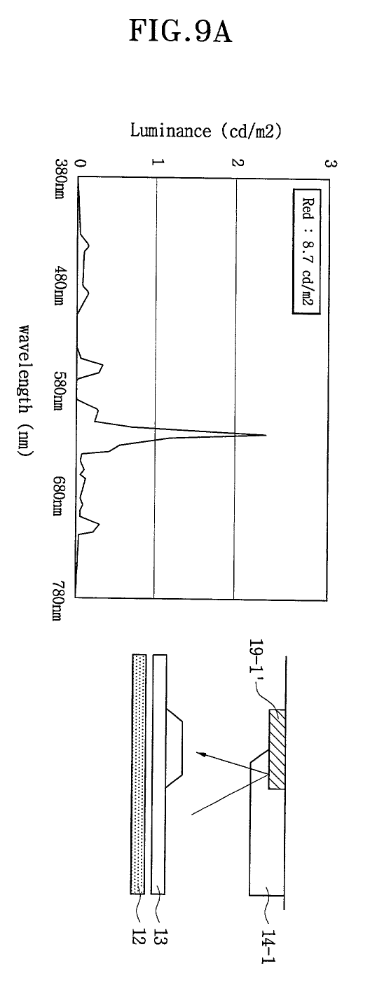

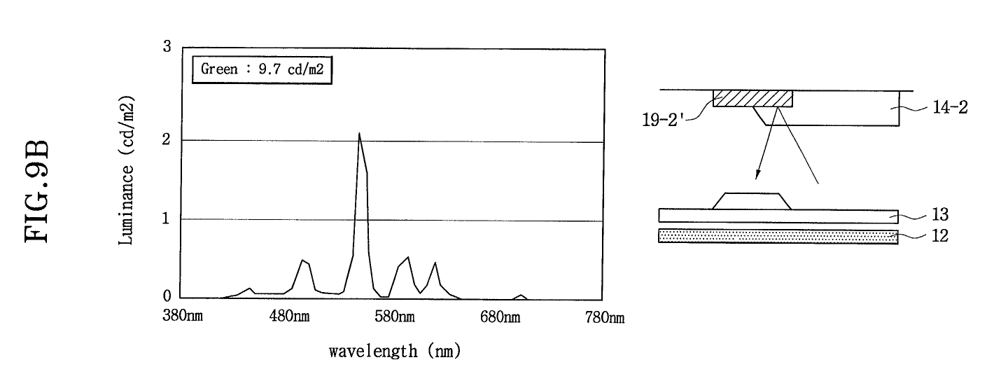

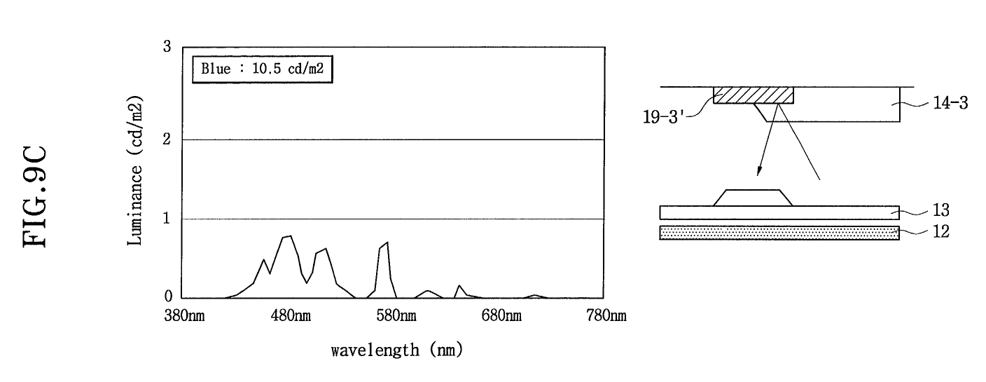

Respective luminance distributions of back light reflected by the black matrix 19-1′, 19-2′, and 19-3′ in FIG. 7 are depicted in FIGS. 9A to 9C.

FIG. 9A illustrates the luminance distribution of the back light reflected by the black matrix 19-1′ after passing through the R color filter layer, FIG. 9B illustrates the luminance distribution of the back light reflected by the black matrix 19-2′ after passing through the G color filter layer, and FIG. 9C illustrates the luminance distribution of the back light reflected by the black matrix 19-3′ after passing through the B color filter layer.

Referring to FIGS. 9A to 9C, it can be found that the back light reflected by the black matrix 19-1′ after passing though the R color filter layer 14-1 exhibits a luminance of 8.7 cd/m², the back light reflected by the black matrix 19-2′ after passing though the G color filter layer 14-2 exhibits a luminance of 9.7 cd/m², and the back light reflected by the black matrix 19-3′ after passing though the B color filter layer 14-3 exhibits a luminance of 10.5 cd/m². Since the luminance sum of the back light reflected by the black matrix 19-1′, 19-2′, and 19-3′ is 28.9 cd/m², the black matrix exhibits a reflectivity of 5.2% (28.9/559×100). As compared to the LCD having the conventional simple shield type black matrix, the LCD having black matrix in FIG. 7 exhibits a reduced reflectivity of 10.3% (8.7/839×100) in the case of the black matrix 19-1′, 10.7% (8.7/90.4×100) in the case of the black matrix 19-2′, and 10.9% (28.9/265×100) in the case of the black matrix 19-3′. It can also be found that the sum of back light reflected by the black matrix 19-1′, 19-2′, and 19-3′ is reduced to 10.9% (28.9/265×100).

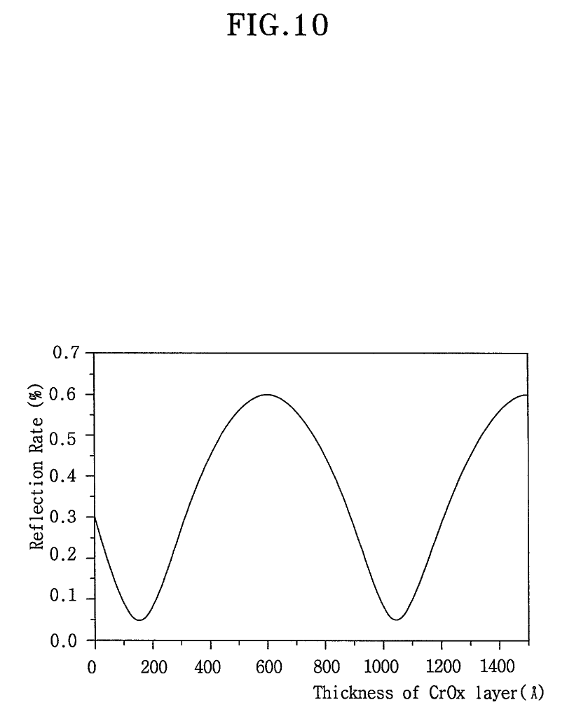

FIG. 10 is a graph depicting a variation in reflectivity depending on the thickness of the chromium oxide layer 43 in the LCD of FIG. 7. In the graph of FIG. 10, the abscissa is indicative of the thickness of the chromium oxide layer 43 whereas the ordinate is indicative of the reflectivity or reflection rate. The depicted reflectivity is based on the wavelength of 589 nm. Referring to FIG. 10, it can be found that a minimum reflectivity of about 0.05 is obtained when the chromium oxide layer 43 has a thickness ranging from about 150 Å to 1,000 Å.

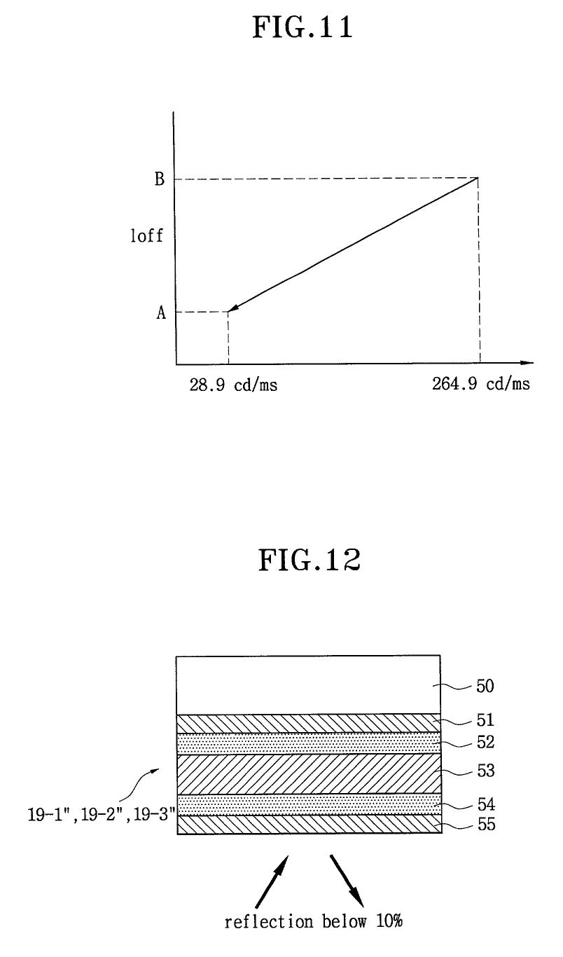

FIG. 11 is a graph depicting a variation in off current in each thin film transistor included in the LCD of FIG. 7. In the graph of FIG. 11, the abscissa is indicative of the luminance sum of back light respectively reflected by the black matrixes 19-1′, 19-2′, and 19-3′ whereas the ordinate is indicative of the off current in the thin film transistor. Referring to FIG. 11, it can be found that the off current A of the thin film transistor included in the LCD having the black matrixes 19-1′, 19-2′, and 19-3′ in FIG. 7 is considerably reduced, as compared to the off current B of the thin film transistor in the conventional LCD of FIG. 1.

Although the internal photo-interference layer of the black matrix according to the above-described embodiment has a single-layer structure, it may have a double-layer structure, as shown in FIG. 12.

FIG. 12 is a sectional view illustrating black matrixes of low reflectivity according to another embodiment of the present invention.

The black matrixes 19-1″, 19-2″, and 19-3″ shown in FIG. 12 respectively correspond to the black matrixes 19-1, 19-2, and 19-3 of FIG. 1. The black matrix comprises a chromium nitride layer 51 formed over the back surface of a front substrate 50 corresponding to the front substrate 15 of FIG. 1, a chromium oxide layer 52 formed over the chromium nitride layer 51, a chromium layer 53 formed over the chromium oxide layer 52, a chromium oxide layer 54 formed over the chromium layer 53, and a chromium nitride layer 55 formed over the chromium oxide layer 54. The chromium nitride layer 51 and chromium oxide layer 52 serve as an external photo-interference layer. The chromium layer 53 serves as a photoshield layer whereas the chromium oxide layer 54 and chromium nitride layer 55 serve as an internal photo-interference layer.

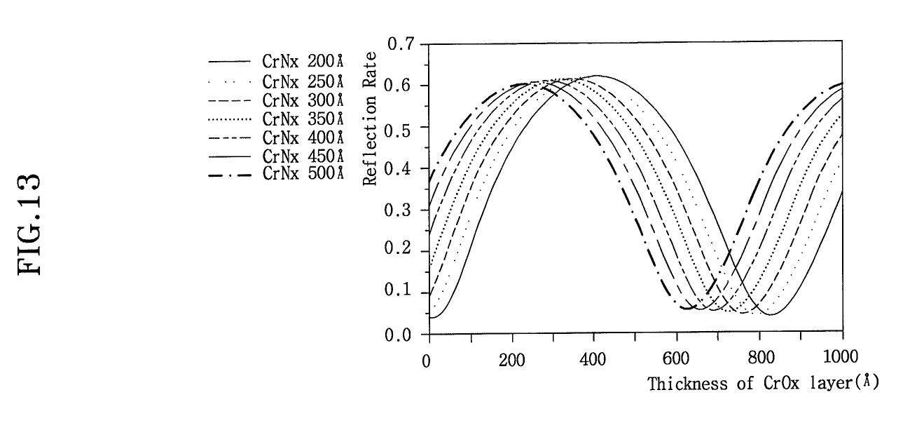

The principle of the reflection of back light being reduced by the black matrixes having the internal photo-interference layer with a double-layer structure is identical to that of the black matrix having the internal photo-interference layer with a single-layer structure illustrated in FIG. 7. That is, the reflection of back light by the black matrixes can be reduced by adjusting the thickness and refraction index of the chromium nitride layer 55, the thickness and refraction index of the chromium oxide layer 54, and the thickness and refraction index of the chromium layer 53 such that both the back light reflected at the interface between the chromium nitride layer 55 and chromium oxide layer 54 and the back light reflected at the interface between chromium oxide layer 54 and the chromium layer 53 destructively interfere with the back light reflected at the interface between the liquid crystal layer 17 and chromium nitride layer FIG. 13 is a graph depicting the relation between the thickness and reflectivity of the chromium oxide layer depending on the thickness of the chromium nitride layer in the LCD of FIG. 12. In the graph of FIG. 13, the abscissa is indicative of the thickness of the chromium oxide layer 54 whereas the ordinate is indicative of the reflectivity. Respective relations between thickness and reflectivity depicted in FIG. 13 are based on the wavelength of 589 nm and the conditions in which: the chromium nitride layer 55 has respective thicknesses of 200 Å, 250 Å, 300 Å, 350 Å, 400 Å, 450 Å, and 500 Å; the chromium nitride layer 55 has a refraction index of 2.8; the chromium oxide layer 54 has a thickness of 0 to 1,000 Å; the chromium oxide layer 54 has a refraction index of 3.5; and the chromium layer 53 has a refraction index of 2.0.

Referring to the graph of FIG. 13, it can be found that a minimum reflectivity of about 0.03 is obtained when the chromium oxide layer 54 has a thickness of about 50 Å or about 800 Å.

The previously described versions of the present invention have many advantages, including the following advantages.

In accordance with the present invention, it is possible to reduce the reflection of the back light, already passing though the liquid crystal layer, again into the liquid crystal layer by adding an internal photo-interference layer to the black matrix having the conventional simple shield type structure or the conventional external light anti-reflection type structure. Accordingly, it is possible to achieve a reduction in flicker and an improvement in visual recognizability.

Although the present invention has been described in considerable detail with reference to certain preferred versions thereof, other versions are possible.

For example, the external photo-interference layer may have a double-layer structure while the internal photo-interference layer may have a single-layer structure, and vice versa. In this case, the double-layer structure may consists of a chromium oxide layer, and a chromium nitride layer whereas the single-layer structure may consists of a chromium oxide layer.

Therefore, the spirit and scope of the appended claims should not be limited to the description of the preferred versions contained herein.

What is claimed is:

1. A liquid crystal display including a front substrate on which color filters and black matrixes are formed such that the black matrixes are respectively arranged between adjacent ones of the color filters, wherein the black matrix comprises:
a photoshield layer formed on a back surface of the front substrate; and
at least one internal photo-interference layer formed over the photoshield layer, the internal photo-interference layer having a refraction index different from that of the photoshield layer.

2. The liquid crystal display according to claim 1, wherein the photoshield layer is a chromium layer.

3. The liquid crystal display according to claim 1, wherein the black matrix further comprises:
at least one external photo-interference layer formed between the front substrate and the photoshield layer, the external photo-interference layer having a refraction index different from that of the photoshield layer.

4. The liquid crystal display according to claim 3, wherein the external photo-interference layer and the internal photo-interference layer have respectively a single-layer structure.

5. The liquid crystal display according to claim 4, wherein the single-layer structure consists of a chromium oxide layer.

6. The liquid crystal display according to claim 3, wherein the external photo-interference layer and the internal photo-interference layer have respectively a double-layer structure.

7. The liquid crystal display according to claim 6, wherein the double-layer structure consists of a chromium oxide layer and a chromium nitride layer.

8. The liquid crystal display according to claim 3, wherein one of the internal photo-interference layer and the external photo-interference layer has a single-layer structure and the other has a double-layer structure.

9. The liquid crystal display according to claim 8, wherein the double-layer structure consists of a chromium oxide layer and a chromium nitride layer, and the single-layer structure consists of a chromium oxide layer.
